(19) United States
(12) Patent Application Publication
(10) Pub. No.: US 2025/0203035 A1
(43) Pub. Date: Jun. 19, 2025

(54) ELECTRONIC DEVICE AND METHOD PROVIDING SLOW SHUTTER FUNCTION

(71) Applicant: Samsung Electronics Co., Ltd., Suwon-si (KR)

(72) Inventors: Changwoo LEE, Suwon-si (KR); Jaehun CHO, Suwon-si (KR)

(21) Appl. No.: 19/067,132

(22) Filed: Feb. 28, 2025

Related U.S. Application Data
(63) Continuation of application No. PCT/KR2023/015602, filed on Oct. 11, 2023.

(30) Foreign Application Priority Data
Oct. 12, 2022 (KR) 10-2022-0130586
Dec. 6, 2022 (KR) 10-2022-0168930

(51) Int. Cl. H04N 5/262; H04N 23/667; H04N 23/68; H04N 23/71

(52) U.S. Cl. CPC H04N 5/2621; H04N 23/667; H04N 23/683; H04N 23/71

(57) ABSTRACT

An electronic device is provided. The electronic device includes memory storing one or more computer programs, a camera module, and one or more processors communicatively coupled to the camera module and the memory, wherein the one or more computer programs include computer-executable instructions that, when executed by the one or more processors individually or collectively, cause the electronic device to acquire a plurality of consecutive images by using the camera module, perform hand shaking correction for the plurality of images, select, from the plurality of images for which hand shaking correction has been performed, first images included in a stabilization section determined based on a motion vector, determine whether shooting is daytime shooting or nighttime shooting, based on luminance components associated with the plurality of images, and generate a second image, which is a slow shutter image, by synthesizing the selected first images, based on determining that the shooting is the daytime shooting.

### CROSS-REFERENCE TO RELATED APPLICATION(S)

This application is a continuation application, claiming priority under 35 U.S.C. § 365(c), of an International application No. PCT/KR2023/015602, filed on Oct. 11, 2023, which is based on and claims the benefit of a Korean patent application number 10-2022-0130586, filed on Oct. 12, 2022, in the Korean Intellectual Property Office, and of a Korean patent application number 10-2022-0168930, filed on Dec. 6, 2022, in the Korean Intellectual Property Office, the disclosure of each of which is incorporated by reference herein in its entirety.

### BACKGROUND

### 1. Field

The disclosure relates to an electronic device and method for providing a slow shutter function.

### 2. Description of Related Art

Portable electronic devices (hereinafter referred to as “electronic devices”), such as a compact system camera (CSC) or a smartphone can adjust parameters, such as a camera's shutter speed, international organization for standardization (ISO), or aperture so as to perform appropriate exposure shooting.

Electronic devices including a CSC or a camera can provide a slow shutter function for photographing a subject for a long period of time by adjusting the above parameters. The slow shutter function may be a photographing technique that expresses the trajectory of a moving object (e.g., a tail lamp of a vehicle in a night environment) or the flow of a fluid (e.g., a waterfall or a fountain).

The above information is presented as background information only to assist with an understanding of the disclosure. No determination has been made, and no assertion is made, as to whether any of the above might be applicable as prior art with regard to the disclosure.

### SUMMARY

To implement the slow shutter function, the CSC can perform one read-out after a long exposure by adjusting the aperture.

The electronic device may include a camera that does not support a variable aperture. To implement the slow shutter function, the electronic device can acquire a plurality of images by performing multiple read-outs with an appropriate exposure and synthesize the plurality of images.

In the case where a user holds the electronic device in his/her hand and photographs a subject for a long period of time (e.g., handheld shooting) without a fixed stand (e.g., tripod), the electronic device may obtain a blurry image due to the user's hand shaking. The electronic device may perform hand shaking correction to prevent blurring of the image due to the user's hand shaking. The hand shaking correction may include optical image stabilization (OIS) correction, digital image stabilization (DIS) correction, or electrical image stabilization (EIS) correction.

The electronic device can acquire a slow shutter image by synthesizing the plurality of obtained images after performing hand shaking correction (e.g., digital image stabilization correction). The hand shaking correction, such as digital image stabilization correction is a method of correcting a motion relationship between continuously input images, and thus may include errors. If the electronic device synthesizes such images in which errors have accumulated, the quality of the final synthesized image (e.g., slow shutter image) may be degraded.

Aspects of the disclosure are to address at least the above-mentioned problems and/or disadvantages and to provide at least the advantages described below. Accordingly, an aspect of the disclosure is to provide an electronic device and method capable of acquiring a slow shutter image of relatively high quality by selecting at least some images corresponding to a stabilization section in which a motion relationship between images is corrected within a specified range among a plurality of obtained images and then synthesizing the selected images.

Additional aspects will be set forth in part in the description which follows and, in part, will be apparent from the description, or may be learned by practice of the presented embodiments.

In accordance with an aspect of the disclosure, an electronic device is provided. The electronic device includes memory storing one or more computer programs, a camera module, and one or more processors communicatively coupled to the camera module and the memory, wherein the one or more computer programs include computer-executable instructions that, when executed by the one or more processors individually or collectively, cause the electronic device to acquire a plurality of consecutive images by using the camera module, perform hand shaking correction for the plurality of images, select, from the plurality of images with hand shaking correction performed, first images included in a stabilization section determined based on a motion vector, determine whether shooting is daytime shooting or nighttime shooting, based on luminance components associated with the plurality of images, and generate a second image, which is a slow shutter image, by synthesizing the selected first images, based on determining that the shooting is the daytime shooting.

In accordance with another aspect of the disclosure, a method performed by an electronic device is provided. The method includes acquiring, by the electronic device, a plurality of consecutive images by using a camera module of the electronic device, performing, by the electronic device, hand shaking correction for the plurality of images, selecting, by the electronic device, from the plurality of images with hand shaking correction performed, first images included in a stabilization section determined based on a motion vector, determining, by the electronic device, whether shooting is daytime shooting or nighttime shooting, based on luminance components associated with the plurality of images, and generating, by the electronic device, a second image, which is a slow shutter image, by synthesizing the selected first images, based on determining that the shooting is the daytime shooting.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include acquiring, by the electronic device, a plurality of consecutive images by using a camera module of the electronic device, performing, by the electronic device, hand shaking correction for the plurality of images, selecting, by the electronic device from the plurality of images with hand shaking correction performed, first images included in a stabilization section determined based on a motion vector, determining, by the electronic device, whether shooting is daytime shooting or nighttime shooting, based on luminance components associated with the plurality of images, and generating, by the electronic device, a second image, which is a slow shutter image, by synthesizing the selected first images, based on determining that the shooting is the daytime shooting.

The electronic device and method according to an embodiment of the disclosure acquire a slow shutter image of relatively high quality by selecting at least some images corresponding to a stabilization section in which a motion relationship between images is corrected within a specified range among a plurality of images and then synthesizing the selected images.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram illustrating a camera module according to an embodiment of the disclosure;

FIG. 3A is a block diagram illustrating components of an electronic device according to an embodiment of the disclosure;

FIG. 3B is a block diagram illustrating components of an electronic device according to an embodiment of the disclosure;

FIG. 4 illustrates a plurality of consecutive images acquired through a camera module according to an embodiment of the disclosure;

FIG. 5 illustrates results of performing horizontal and vertical corrections on a plurality of images according to an embodiment of the disclosure;

FIG. 6 illustrates a result of performing rotation correction on a plurality of images according to an embodiment of the disclosure;

FIG. 7 is a conceptual diagram illustrating that an electronic device determines a stabilization section in a plurality of consecutive images according to an embodiment of the disclosure;

FIG. 8 illustrates a buffer size for searching for a stabilization section in a plurality of consecutive images by an electronic device according to an embodiment of the disclosure;

FIG. 9 illustrates a method for an electronic device to search for a stabilization section in a plurality of consecutive images according to an embodiment of the disclosure;

FIG. 10 illustrates a modeling result corresponding to panning shooting using an electronic device according to an embodiment of the disclosure;

FIG. 11 illustrates a modeling result corresponding to shaking shooting using an electronic device according to an embodiment of the disclosure;

FIG. 12 illustrates a modeling result corresponding to shaking-free shooting using an electronic device according to an embodiment of the disclosure;

FIG. 13 is a conceptual diagram illustrating a method for an electronic device to select one section from among a plurality of stabilization sections according to an embodiment of the disclosure;

FIG. 14 is a conceptual diagram illustrating a method for an electronic device to select one section from among a plurality of stabilization sections according to an embodiment of the disclosure;

FIG. 15 is a conceptual diagram illustrating a method for an electronic device to determine a ratio for synthesizing selected first images according to an embodiment of the disclosure;

FIG. 16 is a conceptual diagram illustrating a method for an electronic device to determine a ratio for synthesizing selected first images according to an embodiment of the disclosure;

FIG. 17 is a flowchart illustrating operations of an electronic device according to an embodiment of the disclosure; and

FIG. 18 is a flowchart illustrating operations for an electronic device to determine a method for synthesizing images based on whether or not the shooting is daytime shooting according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

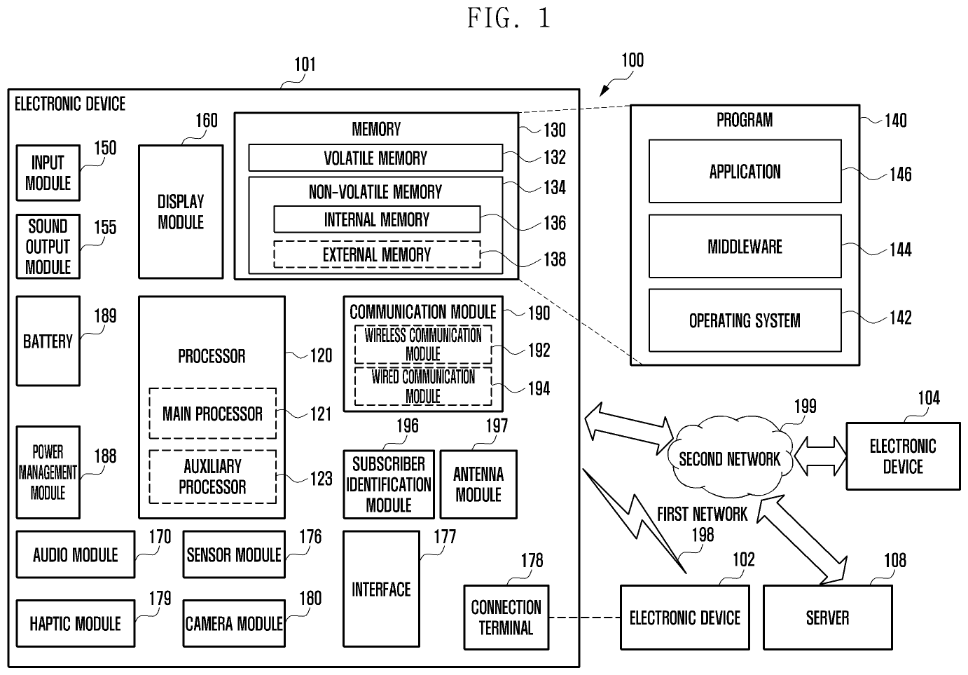

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the 11 connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) there between via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

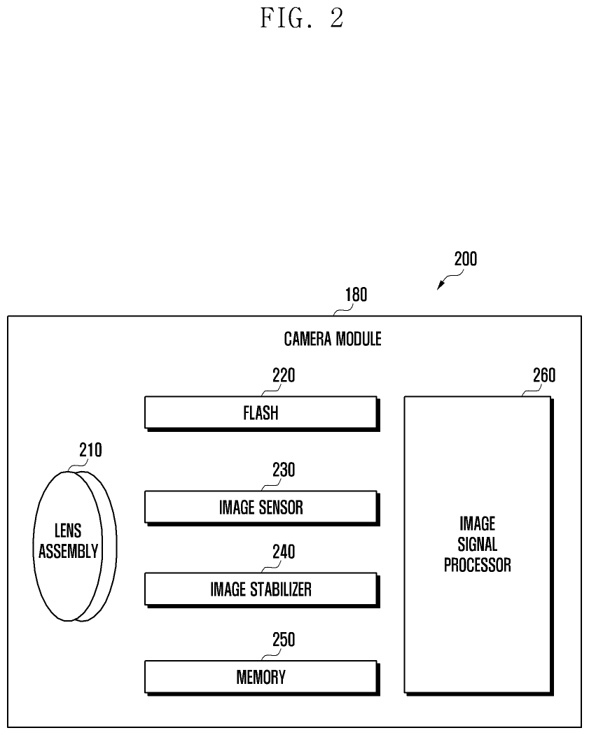

FIG. 2 is a block diagram 200 illustrating a camera module according to an embodiment of the disclosure.

Referring to FIG. 2, the camera module 180 may include a lens assembly 210, a flash 220, an image sensor 230, an image stabilizer 240, memory 250 (e.g., buffer memory), or an image signal processor 260. The lens assembly 210 can collect light emitted from a subject that is a target of image photographing. The lens assembly 210 may include one or more lenses. According to an embodiment of the disclosure, the camera module 180 may include a plurality of lens assemblies 210. In this case, the camera module 180 may form, for example, a dual camera, a 360-degree camera, or a spherical camera. Some of the plurality of lens assemblies 210 may have the same lens properties (e.g., angle of view, focal length, autofocus, f number, or optical zoom), or at least one lens assembly may have one or more lens properties that are different from the lens properties of the other lens assemblies. The lens assembly 210 may include, for example, a wide-angle lens or a telephoto lens.

The flash 220 can emit light used to enhance light emitted or reflected from a subject. According to an embodiment of the disclosure, the flash 220 may include one or more light-emitting diodes (LEDs, e.g., a red-green-blue (RGB) LED, a white LED, an infrared LED, or an ultraviolet LED), or a xenon lamp. The image sensor 230 can convert light emitted or reflected from a subject and transmitted through the lens assembly 210 into an electrical signal, thereby acquiring an image corresponding to the subject. According to an embodiment of the disclosure, the image sensor 230 may include one image sensor selected from among image sensors having different properties, such as, for example, an RGB sensor, a black and white (BW) sensor, an infrared ray (IR) sensor, or an ultraviolet (UV) sensor, a plurality of image sensors having the same property, or a plurality of image sensors having different properties. Each image sensor included in the image sensor 230 may be implemented using, for example, a charged coupled device (CCD) sensor or a complementary metal oxide semiconductor (CMOS) sensor.

The image stabilizer 240 can, in response to the motion of the camera module 180 or the electronic device 101 including the same, move at least one lens included in the lens assembly 210 or the image sensor 230 in a specific direction or control the operating characteristics of the image sensor 230 (e.g., adjust read-out timing, or the like). This allows compensating for at least a part of the negative impact of the motion on the image being photographed. According to an embodiment of the disclosure, the image stabilizer 240 can detect the motion of the camera module 180 or the electronic device 101 by using a gyro sensor (not shown) or an acceleration sensor (not shown) disposed inside or outside the camera module 180. According to an embodiment of the disclosure, the image stabilizer 240 may be implemented as, for example, an optical image stabilizer. The memory 250 can temporarily store at least some of images acquired through the image sensor 230 for the next image processing task. For example, when image acquisition is delayed due to a shutter, or when a plurality of images are acquired at high speed, the acquired original image (e.g., a Bayer-patterned image or a high-resolution image) may be stored in the memory 250, and a corresponding copy image (e.g., a low-resolution image) may be previewed through a display module (e.g., the display module 160 in FIG. 1). Thereafter, when a specified condition (e.g., a user input or a system command) is satisfied, at least some of the original images stored in the memory 250 may be acquired and processed by, for example, the image signal processor 260. According to an embodiment of the disclosure, the memory 250 may be configured as at least a portion of memory (e.g., the memory 130 in FIG. 1) or as separate memory that operates independently therefrom.

The image signal processor 260 can perform one or more image processing operations on an image acquired through the image sensor 230 or an image stored in the memory 250. The one or more image processing operations may include, for example, depth map generation, 3D modeling, panorama generation, feature point extraction, image synthesis, or image compensation (e.g., noise reduction, resolution adjustment, brightness adjustment, blurring, sharpening, or softening). Additionally or alternatively, the image signal processor 260 may perform control (e.g., exposure time control, read-out timing control, or the like) for at least one (e.g., the image sensor 230) of the components included in the camera module 180. The image processed by the image signal processor 260 may be stored back in the memory 250 for further processing or may be provided to an external component (e.g., the memory 130, the display module 160, an electronic device (e.g., the external electronic device 102 in FIG. 1), an electronic device (e.g., the external electronic device 104 in FIG. 1), or a server (e.g., the server 108 in FIG. 1)) of the camera module 180. According to an embodiment of the disclosure, the image signal processor 260 may be configured as at least a part of a processor (e.g., the processor 120 in FIG. 1) or may be configured as a separate processor that operates independently of the processor 120. When the image signal processor 260 is configured as a separate processor from the processor 120, at least one image processed by the image signal processor 260 may be displayed through the display module 160 as is or after undergoing additional image processing by the processor 120.

According to an embodiment of the disclosure, the electronic device (e.g., the electronic device 101 in FIG. 1) may include the plurality of camera modules 180 having different properties or functions. In this case, for example, at least one of the plurality of camera modules 180 may be a wide-angle camera, and at least another may be a telephoto camera. Similarly, at least one of the plurality of camera modules 180 may be a front camera, and at least another may be a rear camera.

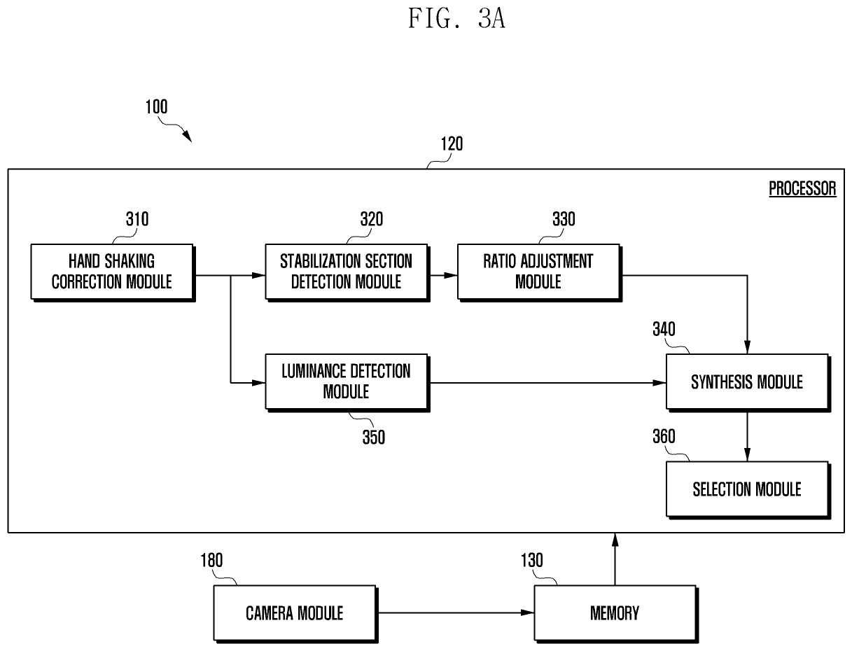

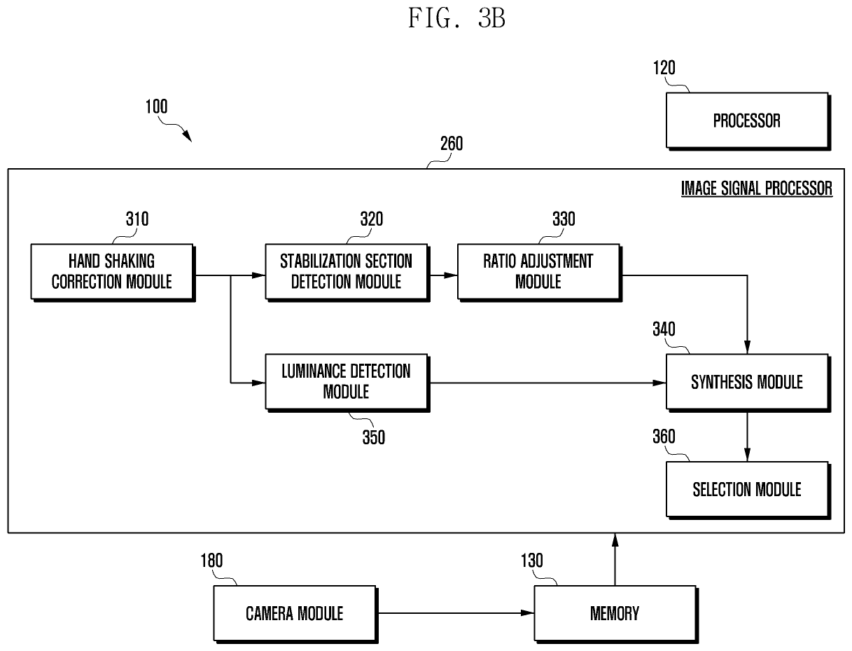

FIG. 3A is a block diagram illustrating components of an electronic device 101 according to an embodiment of the disclosure.

FIG. 3B is a block diagram illustrating components of an electronic device according to an embodiment of the disclosure.

Referring to FIG. 3A, an electronic device 101 (e.g., the electronic device 101 of FIG. 1) according to an embodiment of the disclosure may include a processor 120 (e.g., the processor 120 in FIG. 1), a camera module 180 (e.g., the camera module 180 in FIG. 1), or memory 130 (e.g., the memory 130 in FIG. 1). The processor 120 may include a hand shaking correction module 310, a stabilization section detection module 320, a ratio adjustment module 330, a synthesis module 340, a luminance detection module 350, or a selection module 360.

According to an embodiment of the disclosure, these modules 310, 320, 330, 340, 350, and 360 may be hardware modules or software modules, and if implemented as software, may include at least one instruction that is stored in the memory 130 and executed by the processor 120. In this case, the operation of the software module may be understood as the operation of the processor 120.

At least some of the modules included in the processor 120 in FIG. 3A may be included in the image signal processor 260 described with reference to FIG. 2. For example, referring to FIG. 3B, the electronic device 101 according to an embodiment may include the image signal processor 260, which may include the hand shaking correction module 310, the stabilization section detection module 320, the ratio adjustment module 330, the synthesis module 340, the luminance detection module 350, or the selection module 360.

According to an embodiment of the disclosure, the hand shaking correction module 310 can receive a plurality of images photographed through the camera module 180 and perform hand shaking correction on the plurality of input images. The plurality of images may be continuously captured images and may be raw images (e.g., raw data) decoded using a designated codec. The hand shaking correction module 310 can acquire the plurality of decoded images by referring to the memory 130. The hand shaking correction module 310 can acquire information corresponding to hand shaking from the plurality of input images and perform hand shaking correction based on the acquired information. The information corresponding to hand shaking may include at least one of horizontal movement, vertical movement, rotation based on the center of the optical axis, tilt, distortion of the image sensor of the camera module 180 (e.g., rolling shutter distortion of a CMOS sensor), yaw movement, and/or depth movement (e.g., zoom in or zoom out). In the above, the optical axis may refer to an axis or a unique point corresponding to the center of the lens. For example, the optical axis may be defined as an axis or a unique point that does not change optically (or geometrically) even when a curved surface of the lens is rotated around the optical axis.

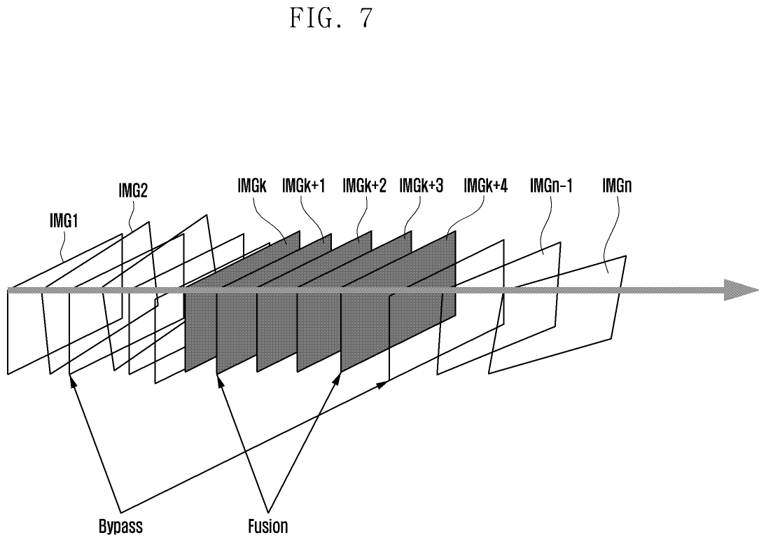

According to an embodiment of the disclosure, the stabilization section detection module 320 can receive a plurality of images with hand shake corrected, and select first images corresponding to a stabilization section from among the plurality of input images. The stabilization section may refer to images photographed in a section without hand shaking (or a section with relatively little hand shaking) among the plurality of images. For example, the electronic device 101 may acquire ‘n’ consecutive images using the camera module 180. The ‘n’ consecutive images may include images acquired while the user's hand shaking occurs greatly and images acquired while the user's hand shaking occurs relatively little or there is no hand shaking. In the above example, the stabilization section may refer to the images acquired while the user's hand shaking occurs relatively little or there is no hand shake. The first images selected by the stabilization section detection module 320 can be converted into a slow shutter image by being synthesized by the synthesis module 340. An embodiment in which the stabilization section detection module 320 determines the stabilization section will be described later with reference to FIGS. 7 to 14.

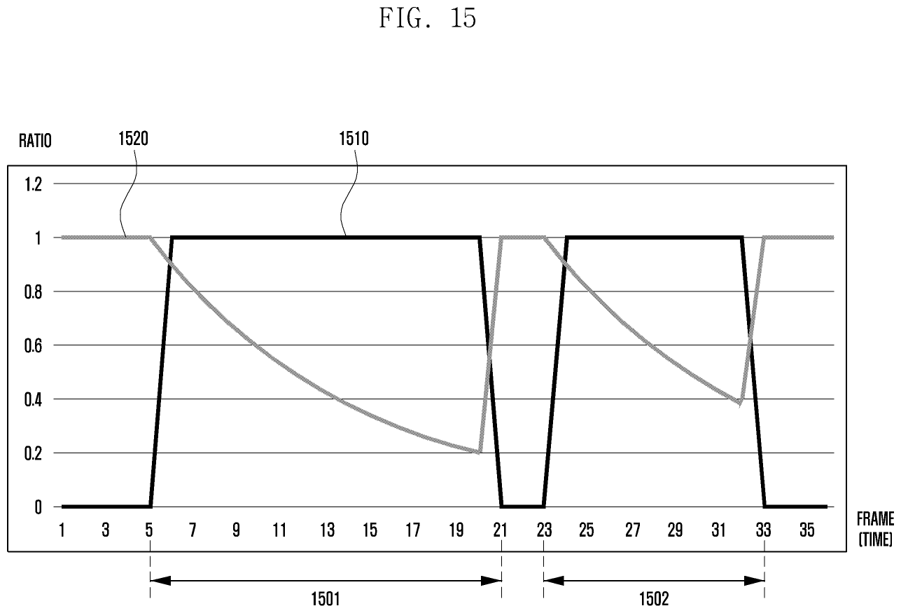

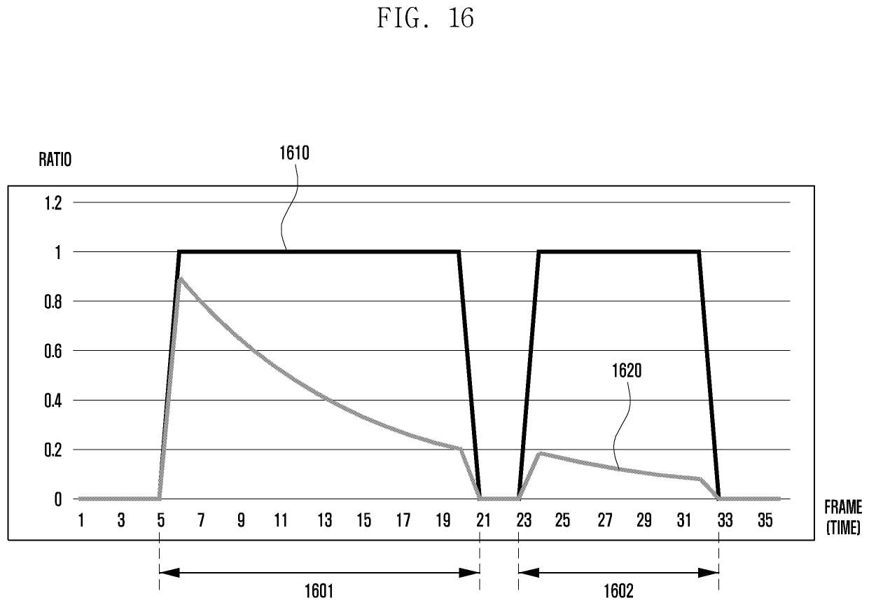

According to an embodiment of the disclosure, the ratio adjustment module 330 may be configured to adjust an image synthesis ratio (or weight) to be used when the synthesis module 340 synthesizes the first images. An embodiment of a method by which the ratio adjustment module 330 adjusts the image synthesis ratio (or weight) will be described later with reference to FIGS. 15 and 16.

According to an embodiment of the disclosure, the synthesis module 340 may be configured to synthesize the first images based on the ratio determined by the ratio adjustment module 330.

According to an embodiment of the disclosure, the luminance detection module 350 can detect luminance components from a plurality of images and, using the detected luminance components, determine whether shooting is performed in the daytime or in the nighttime. For example, the luminance detection module 350 may detect luminance components by region from a single image or at least some images among the plurality of images and calculate a representative value (e.g., a median, a mode, or an average) of the luminance components by region. For example, the luminance detection module 350 may identify the image brightness by region from a single image or at least some images among the plurality of images and calculate a representative value (e.g., a median, a mode, or an average) of the image brightness by region. The luminance detection module 350 may determine that shooting is the daytime shooting if the representative value of the luminance components by region is greater than a specified first threshold value, and determine that shooting is the nighttime shooting if the representative value is less than or equal to the first threshold value. The daytime shooting may indicate that an environment when the electronic device 101 captures the plurality of images using the camera module 180 is a daytime environment. The nighttime shooting may indicate that an environment when the electronic device 101 captures the plurality of images using the camera module 180 is a nighttime environment.

According to an embodiment of the disclosure, the luminance detection module 350 may obtain an illuminance value corresponding to the external illuminance of the electronic device 101 using an illuminance sensor (not shown), and determine whether the shooting is performed in the daytime or in the nighttime based on the obtained illuminance value. For example, the luminance detection module 350 may determine that the shooting is the daytime shooting if the illuminance value obtained using the illuminance sensor is greater than a specified second threshold value, and determine that the shooting is the nighttime shooting if the illuminance value is less than or equal to the second threshold value.

According to an embodiment of the disclosure, based on the determination that the shooting is the daytime shooting, the luminance detection module 350 may control the synthesis module 340 to synthesize the first images corresponding to the stabilization section. The luminance detection module 350 may control the synthesis module 340 to perform synthesis based on a first synthesis scheme when synthesizing the first images. For example, the first synthesis scheme may be a synthesis scheme for evenly expressing the flow of motion, which may be a scheme of synthesizing a previously synthesized image and a newly input image based on a weight.

According to an embodiment of the disclosure, based on the determination that the shooting is the nighttime shooting, the luminance detection module 350 may control the synthesis module 340 to synthesize all of the plurality of images with hand shake corrected by the hand shaking correction module 310. The luminance detection module 350 may control the synthesis module 340 to perform synthesis based on a second synthesis scheme when synthesizing all of the plurality of images with hand shake corrected. For example, the second synthesis scheme may be a synthesis scheme for expressing a trajectory of a peak light source, which may be a synthesis scheme of a light adding scheme (e.g., an additive scheme). The second synthesis scheme may be a scheme for detecting a light area having a luminance value higher than a reference value in a newly input image, and additionally synthesizing the detected light area with a previously synthesized image. In the above, the peak light source may mean a portion of the image corresponding to a light component in a night-shot image.

According to an embodiment of the disclosure, when there are a plurality of images synthesized by the synthesis module 340, the selection module 360 may be configured to select an optimal image from among the plurality of synthesized images. For example, when there are a plurality of stabilization sections detected by the stabilization section detection module 320, the synthesis module 340 may generate a plurality of synthesized images by synthesizing images in each of the plurality of stabilization sections. From among the plurality of synthesized images, the selection module 360 may determine a still image to be output as a final result. For example, from among the plurality of synthesized images, the selection module 360 may output the last synthesized image as the final still image (e.g., a slow shutter image).

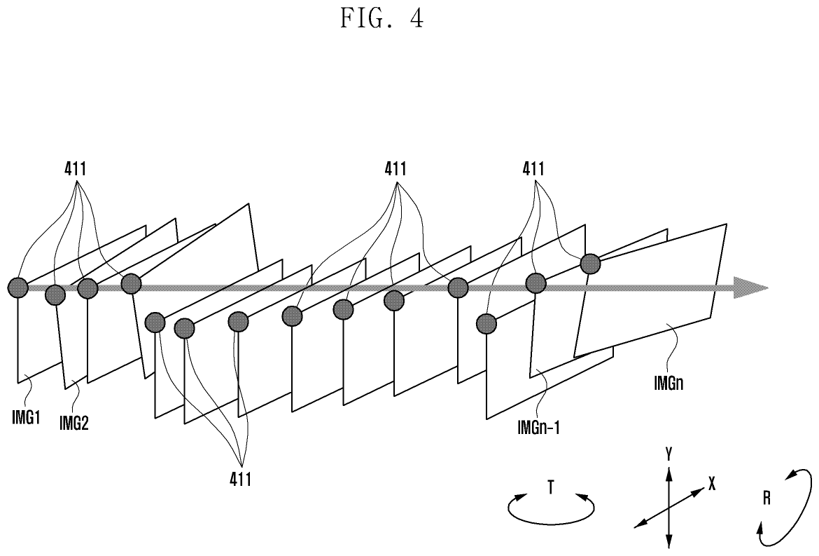

Hereinafter, a method in which the hand shaking correction module (e.g., the hand shaking correction module 310 in FIG. 3A) performs hand shaking correction on a plurality of images will be described with reference to FIGS. 4 to 6.

FIG. 4 illustrates a plurality of consecutive images acquired through a camera module (e.g., the camera module 180 in FIG. 1) according to an embodiment of the disclosure.

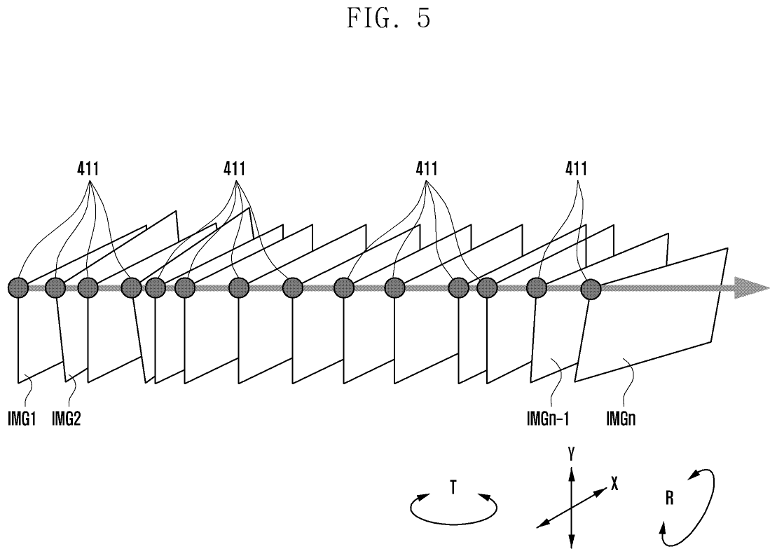

FIG. 5 illustrates results of performing horizontal and vertical corrections on a plurality of images according to an embodiment of the disclosure.

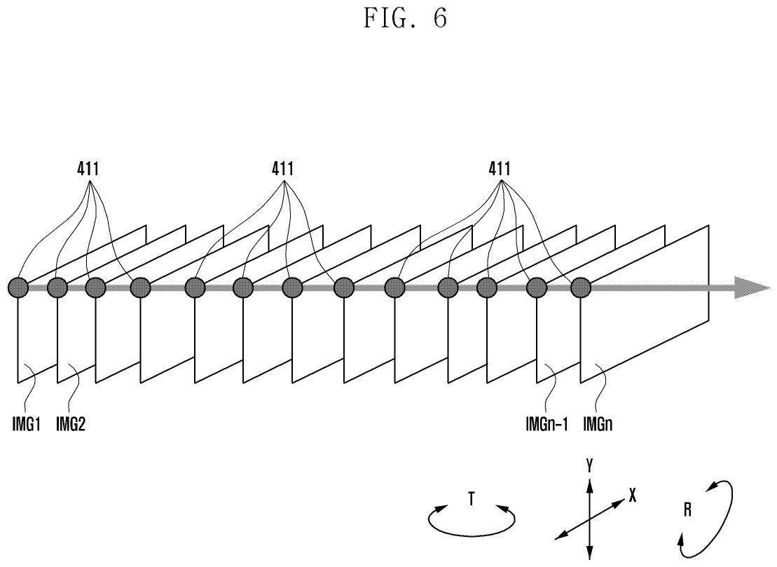

FIG. 6 illustrates a result of performing rotation correction on a plurality of images according to an embodiment of the disclosure.

In FIGS. 4, 5, and 6, a dot 411 may indicate a reference point of each of a plurality of images IMG1 to IMGn. For example, the dot 411 may be a virtual reference point located at the upper left of each image in the image domain where the plurality of images IMG1 to IMGn are input. In FIGS. 4 to 6, the location of the reference point 411 is only an example, and various embodiments of the disclosure may not be limited thereto.

Referring to FIG. 4, it can be seen that the plurality of consecutive images IMG1 to IMGn acquired through the camera module 180 are moving without the location of the reference point 411 being fixed on the time axis due to the user's hand shaking. The hand shaking correction module 310 according to an embodiment may receive the plurality of images IMG1 to IMGn in which the location of the reference point 411 is not fixed on the time axis but is moving, as shown in FIG. 4. For example, the electronic device 101 may acquire the plurality of images IMG1 to IMGn in which the location of a stationary external object corresponding to the reference point 411 is not fixed but is moving in the image domain due to the user's hand shaking.

Referring to FIG. 5, for the plurality of consecutive images IMG1 to IMGn, the hand shaking correction module 310 according to an embodiment can perform motion correction for a horizontal direction (e.g., X direction in FIG. 5) and motion correction for a vertical direction (e.g., Y direction in FIG. 5).

Referring to FIG. 6, for the plurality of consecutive images IMG1 to IMGn, the hand shaking correction module 310 according to an embodiment can perform motion correction for a rotational direction (e.g., R direction in FIG. 6) and motion correction for a tilt direction (e.g., T direction in FIG. 6).

According to an embodiment of the disclosure, the hand shaking correction module 310 can obtain information (e.g., motion information) related to the movement of the electronic device 101 by using an external motion sensor (e.g., 6-Dof) (not shown) of the camera module 180. The hand shaking correction module 310 can obtain motion-related information by performing signal processing in the image domain.

FIG. 7 is a conceptual diagram illustrating that an electronic device determines a stabilization section in a plurality of consecutive images according to an embodiment of the disclosure.

Referring to FIG. 7, the stabilization section detection module (e.g., the stabilization section detection module 320 in FIG. 3A) according to an embodiment can estimate whether movement occurs between adjacent frames for the plurality of images IMG1 to IMGn captured using the camera module (e.g., the camera module 180 in FIG. 1). The stabilization section detection module 320 can determine a hand shaking section and a stabilization section by using a statistical method, and control first images corresponding to the stabilization section to be used for synthesis.

As shown in FIG. 7, the stabilization section detection module 320 can acquire ‘n’ images IMG1 to IMGn, and the ‘n’ images IMG1 to IMGn may be images in which hand shaking correction has been performed by the hand shaking correction module (e.g., the hand shaking correction module 310 in FIG. 3A). For a more accurate synthesis, the stabilization section detection module 320 can perform an operation of searching for a stabilization section on the images IMG1 to IMGn with hand shaking correction performed. The stabilization section detection module 320 can search for first images corresponding to the stabilization section among the images IMG1 to IMGn with hand shaking correction performed so that only the first images are used for synthesis (i.e., fusion), and can bypass images that do not correspond to the stabilization section (e.g., images corresponding to a non-stabilization section) so that they are not used for synthesis. For example, FIG. 7 shows that, among the ‘n’ input images, the stabilization section detection module 320 determines that the kth image IMGk to the k+4th image IMGk+4 correspond to the stabilization section, and controls the kth image IMGk to the k+4th image IMGk+4 to be used for synthesis. For example, FIG. 7 shows that, among the ‘n’ input images, the stabilization section detection module 320 determines that the remaining images, excluding the kth image IMGk to the k+4th image IMGk+4, correspond to the non-stabilization section, and bypasses them so as not to be used for synthesis.

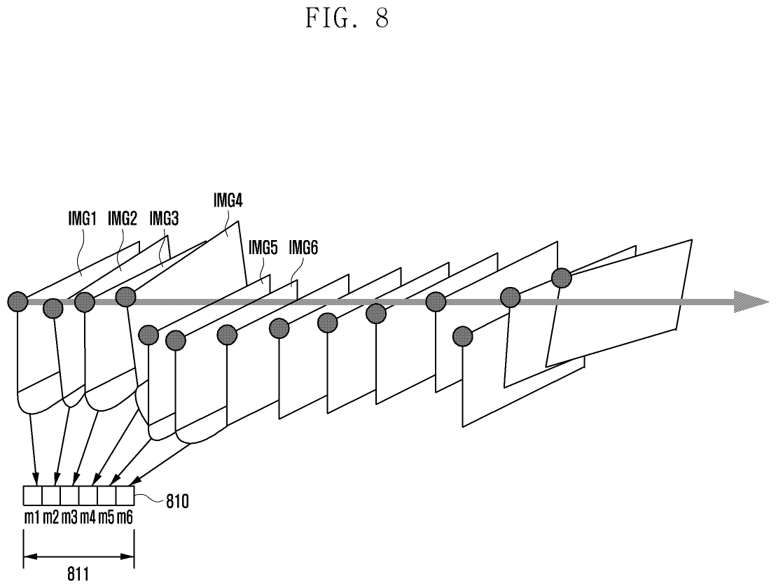

FIG. 8 illustrates a buffer size for searching for a stabilization section in a plurality of consecutive images by an electronic device according to an embodiment of the disclosure.

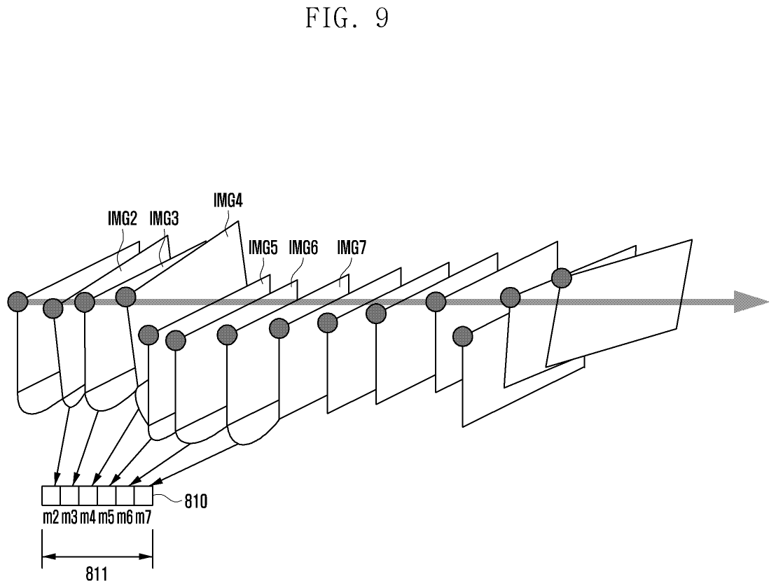

FIG. 9 illustrates a method for an electronic device to search for a stabilization section in a plurality of consecutive images according to an embodiment of the disclosure.

Referring to FIGS. 8 and 9, the stabilization section detection module (e.g., the stabilization section detection module 320 in FIG. 3A) may calculate a motion vector from each of the plurality of images and store the calculated motion vector in buffer memory 810. The buffer memory 810 may be memory within the processor 120 configured to operate in a first-in first-out (FIFO) manner. The buffer memory 810 may be configured to have a specified size 811, and the stabilization section detection module 320 may determine the trend of movements and whether the movements are stabilized, using the motion vectors of the frames corresponding to the buffer size 811 of the buffer memory 810. For example, FIGS. 8 and 9 show that the buffer size 811 of the buffer memory 810 corresponds to six frames, and the buffer memory 810 may store the motion vectors of the images corresponding to six consecutive frames. Using the motion vectors of the images corresponding to six consecutive frames, the stabilization section detection module 320 may determine the trend of movements in the corresponding section and whether the movements are stabilized. The trend of movements may indicate the degree to which the images in a specific section (e.g., the images corresponding to six frames) move in a substantially constant direction. For example, a relatively large trend of movements may indicate that the images in a specific section (e.g., the images corresponding to six frames) are moving in a specific direction. The stabilization of movements may indicate the degree to which the motion vectors are dispersed from the trend of movements. For example, a relatively large stabilization of movements may indicate that the range of error in which the images in a specific section (e.g., the images corresponding to six frames) deviate from the trend of movements is small.

According to an embodiment of the disclosure, the motion vector may be a parameter derived by comparing input images. The motion vector is a motion component including an error residual between adjacent images (e.g., images input continuously), and may refer to a differentiation value within the entire section. The motion vector may not represent a motion component of an image stream in which a plurality of images are input. Therefore, for a section of the image stream of a certain length input to the buffer memory 810, the stabilization section detection module 320 may decide whether the last frame is in motion and, based on this decision, determine whether there is motion.

Referring to FIGS. 8 and 9, the stabilization section detection module 320 may store the motion vectors of images of a specified length (e.g., six frames) in the buffer memory 810 having the specified size 811 and, using the stored motion vectors, determine the trend of movements in the corresponding section and whether the movements are stabilized.

According to an embodiment of the disclosure, the stabilization section detection module 320 capable of storing motion vectors for ‘n’ images in the buffer memory 810 may sequentially store motion vectors corresponding to consecutive images of a specified length. The stabilization section detection module 320 may store motion information (e.g., motion vectors corresponding to frames of a specified length) in the first-in first-out (FIFO) manner (e.g., slide movement manner or shift movement manner) that deletes the first stored motion vector among the motion vectors stored in the buffer memory 810 when a motion vector of a new frame is stored in the buffer memory 810. For example, FIG. 8 shows a state in which six motion vectors from the first motion vector m1 corresponding to the first image IMG1, input firstly, to the sixth motion vector m6 corresponding to the sixth image IMG6, input sixthly, are stored in the buffer memory 810. For example, FIG. 9 shows, as an example of a state after FIG. 8, a state in which six motion vectors from the second motion vector m2 corresponding to the second image IMG2, input secondly, to the seventh motion vector m7 corresponding to the seventh image IMG7, input seventhly, are stored in the buffer memory 810. Although not shown, after the state of FIG. 9, the buffer memory 810 may store the third motion vector m3 corresponding to the third image IMG3, input thirdly, to the eighth motion vector corresponding to the eighth image input eighthly.

According to an embodiment of the disclosure, the stabilization section detection module 320 may determine the trend of movements in the corresponding section and whether the movements are stabilized, by using the motion vectors stored in the buffer memory 810.

According to an embodiment of the disclosure, the stabilization section detection module 320 may accumulatively count the motion vectors stored in the buffer memory 810 and estimate a first-order regression straight line model from the accumulatively counted motion vectors. The first-order regression straight line model can be expressed as in Equation 1.

$$Y = ax + b , where a = \frac{{\sum }_{n = 1}^{m} ( Xn - {X}^{*} ) ( Yn - {Y}^{*} )}{{\sum }_{n = 1}^{m} ( Xn - {X}^{*} )} \qquad Equation 1$$

$$b = {Y}^{*} - {aX}^{*}$$

Here, ‘Y’ is an observation of an actually accumulated motion vector, ‘b’ is an intercept, and ‘a’ is a slope of a first-order regression straight line, and may represent a position in time.

In addition, Xn and Yn are the x-axis and y-axis of the straight line, respectively, in the second-order planar coordinate system, and X* and Y* may be the averages of the x-value and y-value for data on the x-axis, respectively.

Equation 1 is merely an example to help understanding, is not a limitation, and can be modified, applied, or extended in various ways.

According to an embodiment of the disclosure, the stabilization section detection module 320 may calculate a coefficient of determination (R2) representing a ratio of errors between the regression line model and the actual motion, and the coefficient of determination (R2) can be expressed as in Equation 2.

$$R 2 = \frac{SSR}{SSR + SSE} , where \qquad Equation 2$$

$$SSE = {\sum }_{n = 1}^{m} ( Yn - \begin{matrix}∧ \\ Y\end{matrix} )$$

$$SSR = {\sum }_{n = 1}^{m} ( {Y}^{*} - \begin{matrix}∧ \\ Y\end{matrix} )$$

According to an embodiment of the disclosure, the coefficient of determination (R2) may be a value representing the pattern (e.g., array form) of error residuals of actually obtained data. The coefficient of determination (R2) may refer to the sum of error residuals between the regression model and the measured value. For example, the coefficient of determination (R2) being close to “1” may indicate that the accuracy of fitting is high without error residuals between the model and the measured value. The coefficient of determination (R2) being close to “0” may indicate that the error residuals between the model and the measured value are large and the accuracy of fitting is low.

Equation 2 is merely an example to help understanding, and is not a limitation, and can be modified, applied, or extended in various ways.

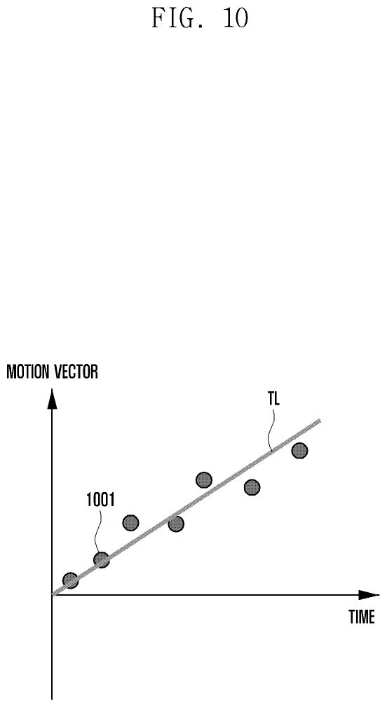

The first-order regression straight line model according to Equation 1 may be represented as the graphs of FIGS. 10 to 12.

FIG. 10 illustrates a modeling result corresponding to panning shooting using an electronic device according to an embodiment of the disclosure.

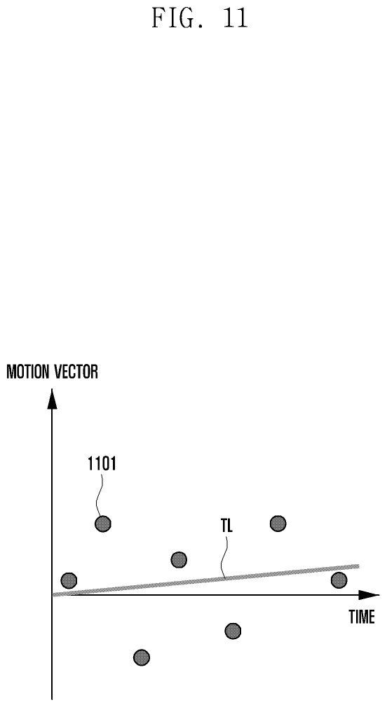

FIG. 11 illustrates a modeling result corresponding to shaking shooting using an electronic device according to an embodiment of the disclosure.

For example, FIG. 11 may represent the results of modeling for images acquired while the user's hand shaking occurs among a plurality of images.

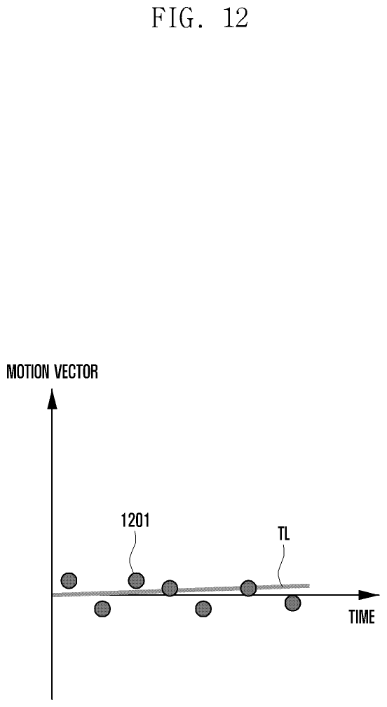

FIG. 12 illustrates a modeling result corresponding to shaking-free shooting using an electronic device according to an embodiment of the disclosure.

For example, FIG. 12 may represent the results of modeling for images acquired while the user's hand shaking does not occur among a plurality of images.

In FIGS. 10, 11, and 12, TL denotes a line representing a regression straight line model according to Equation 1, and may be a trend line representing a trend of movements of motion vectors stored in buffer memory (e.g., the buffer memory 810 in FIG. 8 or 9).

In FIGS. 10, 11, and 12, the slope of the trend line may correspond to ‘a’ in Equation 1.

In FIGS. 10, 11, and 12, dots 1001, 1101, and 1201 may represent accumulatively counted values of motion vectors stored in the buffer memory 810.

Referring to FIG. 10, the slope of the trend line TL is greater than a specified slope value, and the motion vectors accumulated in the time axis may be arranged relatively adjacent to the trend line TL. According to the example of FIG. 10, the coefficient of determination (R2) is close to “1”, which may mean that the accuracy of fitting is high without an error residual between the first regression model and the measured value. According to an embodiment of the disclosure, when the slope of the trend line TL is greater than a specified slope value, and the motion vectors accumulated in the time axis are arranged adjacent to the trend line TL, so that the coefficient of determination (R2) is close to “1” (e.g., when the coefficient of determination is greater than a specified threshold value), the stabilization section detection module (e.g., the stabilization section detection module 320 in FIG. 3A) may determine that the corresponding section is a panning shooting section. The panning shooting may indicate that the user takes a picture while moving the camera in a constant direction at a constant speed.

Referring to FIG. 11, it can be seen that the slope of the trend line TL is less than a specified slope value, and the motion vectors accumulated in the time axis are arranged relatively far (or randomly) from the trend line TL. According to the example of FIG. 11, the coefficient of determination (R2) is close to “0”, and the error residual between the regression model and the measured value is large, which may mean that the accuracy of fitting is low. According to an embodiment of the disclosure, when the slope of the trend line TL is less than a specified slope value, and the motion vectors accumulated in the time axis are arranged relatively far (or randomly) from the trend line TL, so that the coefficient of determination (R2) is close to “0” (e.g., when the coefficient of determination is less than a specified threshold value), the stabilization section detection module (e.g., the stabilization section detection module 320 in FIG. 3A) may determine that the corresponding section is a hand shaking section.

Referring to FIG. 12, it can be seen that the slope of the trend line TL is less than a specified slope value, and the motion vectors accumulated in the time axis are arranged relatively adjacent to the trend line TL. According to the example of FIG. 12, the coefficient of determination (R2) is close to “1”, which may mean that the accuracy of fitting is high without an error residual between the regression model and the measured value. According to an embodiment of the disclosure, when the slope of the trend line TL is less than a specified slope value, and the motion vectors accumulated in the time axis are arranged adjacent to the trend line TL, so that the coefficient of determination (R2) is close to “1” (e.g., when the coefficient of determination is greater than a specified threshold value), the stabilization section detection module (e.g., the stabilization section detection module 320 in FIG. 3A) may determine that the corresponding section is a stabilization section.

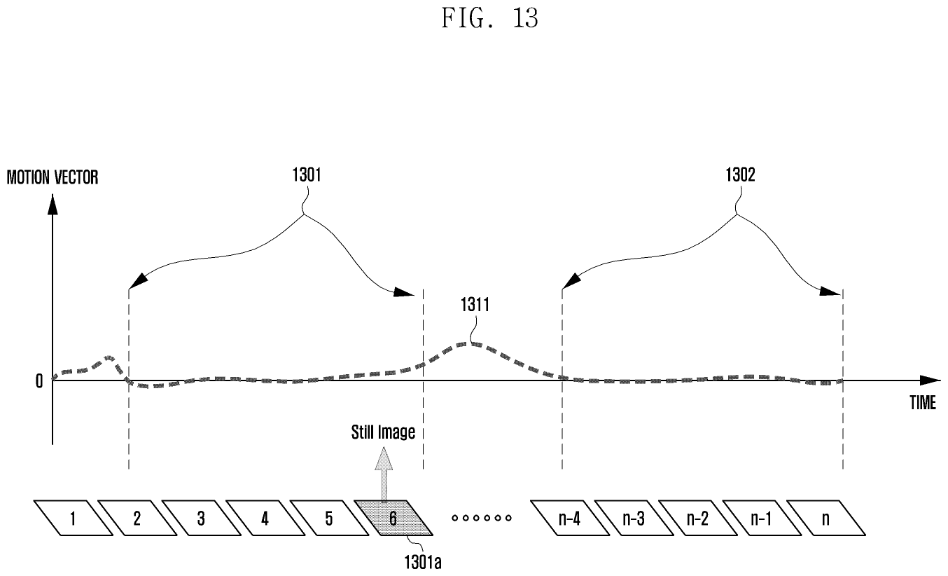

FIG. 13 is a conceptual diagram illustrating a method for an electronic device to select one section from among a plurality of stabilization sections according to an embodiment of the disclosure.

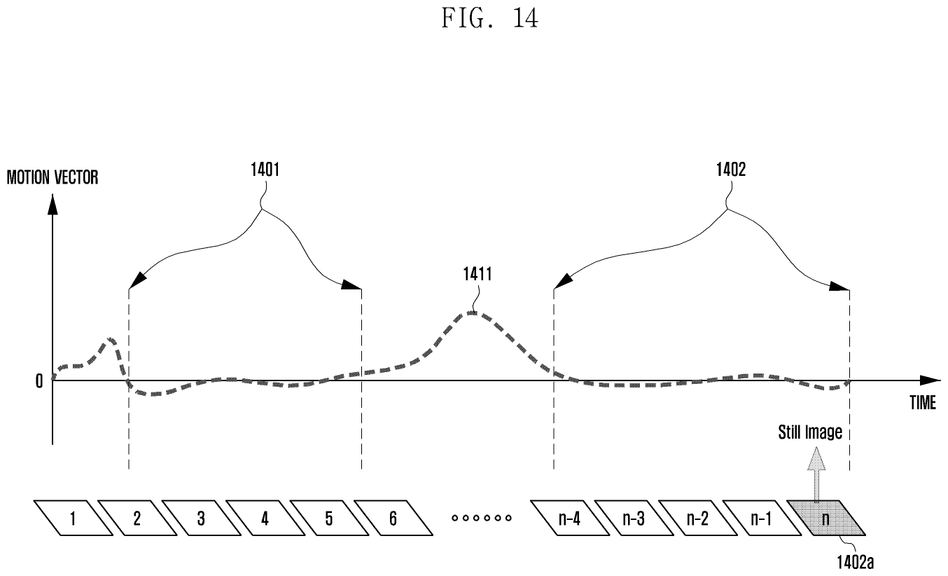

FIG. 14 is a conceptual diagram illustrating a method for an electronic device to select one section from among a plurality of stabilization sections according to an embodiment of the disclosure.

In FIGS. 13 and 14, the horizontal axis represents time, and the vertical axis represents a motion vector. In FIGS. 13 and 14, dotted lines 1311 and 1411 denote motion vectors accumulated over time.

Referring to FIG. 13, the electronic device 101 according to an embodiment can detect a plurality of stabilization sections from an image stream including a plurality of images. For example, in FIG. 13, 1301 denotes a first stabilization section, and 1302 denotes a second stabilization section detected after the first stabilization section. The electronic device 101 (e.g., the stabilization section detection module 320 in FIG. 3A) according to an embodiment may be configured to, when a plurality of stabilization sections are detected, select a stabilization section including more images and synthesize images included in the selected stabilization section. For example, the first stabilization section may be a stabilization section including ‘p’ images, and the second stabilization section may be a stabilization section including ‘q’ images less than ‘p’ images. In this case, the electronic device 101 according to an embodiment may synthesize the ‘p’ images included in the first stabilization section, and output the last image 1301a among the ‘p’ images as a still image.

Referring to FIG. 14, the electronic device 101 according to an embodiment can detect a plurality of stabilization sections from an image stream including a plurality of images. For example, in FIG. 14, 1401 denotes a third stabilization section, and 1402 denotes a fourth stabilization section detected after the third stabilization section. The electronic device 101 (e.g., the stabilization section detection module 320) according to an embodiment may be configured to, when a plurality of stabilization sections are detected, select the last stabilization section and synthesize images included in the selected stabilization section. For example, the third stabilization section may be a stabilization section including ‘r’ images, and the fourth stabilization section may be a stabilization section including ‘s’ images. In this case, the electronic device 101 according to an embodiment may synthesize the ‘s’ images included in the fourth stabilization section, and output the last image 1402a among the ‘s’ images as a still image.

Hereinafter, with reference to FIGS. 15 and 16, it will be described how the electronic device 101 according to an embodiment synthesizes a synthesized image of existing frames and an image of an input frame at what ratio (or by what method).

FIG. 15 is a conceptual diagram illustrating a method for an electronic device to determine a ratio for synthesizing selected first images according to an embodiment of the disclosure.

FIG. 16 is a conceptual diagram illustrating a method for an electronic device to determine a ratio for synthesizing selected first images according to an embodiment of the disclosure.

Referring to FIGS. 15 and 16, the electronic device 101 according to an embodiment can synthesize images based on Equation 3.

$$Output = In 1 \cdot Ratio + In 2 \cdot ( 1 - Ratio ) \qquad Equation 3$$

Here, ‘Output’ denotes an image output by synthesis, ‘In1’ denotes a newly input image, and ‘In2’ denotes a previously synthesized image. When a new image is input, ‘Output’, which is an image output by synthesis, may be replaced with ‘In2’ and become an input value for outputting a new synthesized image. ‘Ratio’ represents a synthesis ratio configured by a ratio adjustment module (e.g., the ratio adjustment module 330 in FIG. 3A).

Equation 3 is merely an example to help understanding, is not a limitation, and can be modified, applied, or extended in various ways.

In FIGS. 15 and 16, the horizontal axis represents frames (e.g., time) of input images, and the vertical axis represents a synthesis ratio applied to Equation 3 and a flag value indicating a stabilization section depending on whether each frame is in a stabilization state.

In FIGS. 15 and 16, 1510 and 1610 denote flag values indicating a stabilization section, which may be expressed as 0 or 1. A section in which the flag value denoted by 1510 or 1610 is 0 may represent a non-stabilization section. A section in which the flag value denoted by 1510 or 1610 is 1 may represent a stabilization section. For example, in FIG. 15, a period from the 5th frame to the 21st frame corresponding to a section 1501 may be a stabilization section. In FIG. 15, a period from the 23rd frame to the 33rd frame corresponding to a section 1502 may be a stabilization section. In FIG. 15, the remaining frame sections except for the sections 1501 and 1502 may be non-stabilization sections. For example, in FIG. 16, a period from the 5th frame to the 21st frame corresponding to a section 1601 may be a stabilization section. In FIG. 16, a period from the 23rd frame to the 33rd frame corresponding to a section 1602 may be a stabilization section. In FIG. 16, the remaining frame sections except for the sections 1601 and 1602 may be non-stabilization sections.

In FIGS. 15 and 16, 1520 and 1620 denote curves indicating a synthesis ratio applied to Equation 3 depending on a stabilization state. The synthesis ratio may be a value greater than or equal to 0 and less than or equal to 1.

Referring to FIG. 15, the ratio adjustment module 330 of the electronic device 101 according to an embodiment may set the synthesis ratio to 1 in the non-stabilization section. For example, the first to fifth frames belong to the non-stabilization section, and the ratio adjustment module 330 of the electronic device 101 according to an embodiment may set the synthesis ratio to 1 so that a newly input image that has not been synthesized is output.

Referring to FIG. 15, the ratio adjustment module 330 of the electronic device 101 according to an embodiment may set the synthesis ratio to a value less than 1 and greater than 0 in the stabilization section, and may set the synthesis ratio to decrease as synthesized frames increase. For example, the fifth to 21st frames belong to the stabilization section, and the ratio adjustment module 330 of the electronic device 101 according to an embodiment may linearly decrease the synthesis ratio from 1 to accumulatively synthesize a newly input image.

Referring to FIG. 15, the ratio adjustment module 330 of the electronic device 101 according to an embodiment may be configured to, when the non-stabilization section is detected after the stabilization section, no longer use the previously synthesized image of the stabilization section and output the newly input image that has not been synthesized. For example, the 22nd frame belongs to the non-stabilization section, and the ratio adjustment module 330 of the electronic device 101 according to an embodiment may output the image of the 22nd frame instead of the cumulative image synthesized during the 5th to 21st frames.

Referring to FIG. 15, if a new stabilization section is detected, the ratio adjustment module 330 of the electronic device 101 according to an embodiment may perform new image synthesis. For example, the 23rd to 33rd frames belong to the stabilization section, and the ratio adjustment module 330 of the electronic device 101 according to an embodiment may synthesize images newly from the 23rd frame.

Referring to FIG. 16, the ratio adjustment module 330 of the electronic device 101 according to an embodiment may set the synthesis ratio to 0 in the non-stabilization section. For example, the first to fifth frames belong to the non-stabilization section, and the ratio adjustment module 330 of the electronic device 101 according to an embodiment may set the synthesis ratio to 0 so that a newly input image is not used for synthesis.

Referring to FIG. 16, the ratio adjustment module 330 of the electronic device 101 according to an embodiment may set the synthesis ratio to a value less than 1 and greater than 0 in the stabilization section, and may set the synthesis ratio to decrease as synthesized frames increase. For example, the fifth to 21st frames belong to the stabilization section, and the ratio adjustment module 330 of the electronic device 101 according to an embodiment may linearly decrease the synthesis ratio from 1 to accumulatively synthesize a newly input image.

Referring to FIG. 16, the ratio adjustment module 330 of the electronic device 101 according to an embodiment may be configured to, when the non-stabilization section is detected after the stabilization section, output the previously synthesized image of the stabilization section. For example, the 22nd frame belongs to the non-stabilization section, and the ratio adjustment module 330 of the electronic device 101 according to an embodiment may output the cumulative image synthesized during the 5th frame to the 21st frame.

Referring to FIG. 16, if a new stabilization section is detected, the ratio adjustment module 330 of the electronic device 101 according to an embodiment may perform additional image synthesis from the result of the previous image synthesis. For example, the 23rd frame to the 33rd frame belong to the stabilization section, and the ratio adjustment module 330 of the electronic device 101 according to an embodiment may perform additional image synthesis from the cumulative image synthesized during the 5th frame to the 21st frame.

Referring to FIG. 16, when a new stabilization section is detected, the ratio adjustment module 330 of the electronic device 101 according to an embodiment may set the synthesis ratio to be less than or equal to the synthesis ratio of the previous stabilization section.

In the case of synthesizing images in the manner described in FIG. 16, the electronic device 101 according to an embodiment can perform cumulative synthesis using the synthesis result of the existing stabilization section, thereby obtaining an image with a relatively large slow shutter effect.

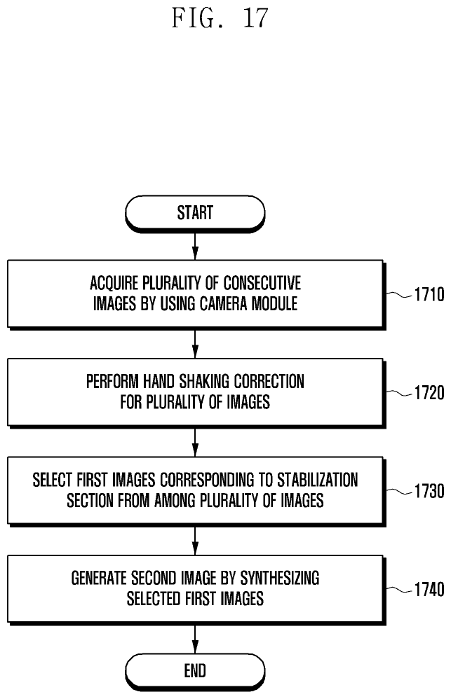

FIG. 17 is a flowchart illustrating operations of an electronic device according to an embodiment of the disclosure.

Referring to FIG. 17, at least some of the operations may be omitted. At least some of operations mentioned with reference to other drawings in the disclosure may be additionally inserted before or after at least some of the operations illustrated in FIG. 17.

In the following embodiment of the disclosure, the respective operations may be performed sequentially, but are not necessarily performed sequentially. For example, the order of respective operations may be changed, and at least two operations may be performed in parallel.

The operations illustrated in FIG. 17 may be performed by the processor 120 (e.g., the processor 120 in FIG. 1). For example, the memory 130 (e.g., the memory 130 in FIG. 1) of the electronic device 101 may store instructions that, when executed, cause the processor 120 to perform at least some of the operations illustrated in FIG. 17. Hereinafter, the operations of the electronic device 101 according to an embodiment will be described with reference to FIG. 17.

Referring to FIG. 17, in operation 1710, the electronic device 101 according to an embodiment may acquire a plurality of consecutive images by using a camera module (e.g., the camera module 180 in FIG. 1). For example, the plurality of images may be acquired by performing a plurality of readouts with appropriate exposure.

In operation 1720, the electronic device 101 according to an embodiment may perform hand shaking correction for the plurality of images. For example, a hand shaking correction module (e.g., the hand shaking correction module 310 in FIG. 3A) may receive a plurality of images captured through the camera module 180 and perform hand shaking correction for the plurality of input images. The hand shaking correction module 310 may acquire information corresponding to hand shaking from the plurality of input images and perform hand shaking correction based on the acquired information. The information corresponding to hand shaking may include horizontal movement, vertical movement, rotation based on the center of the optical axis, tilt, distortion of the image sensor of the camera module 180 (e.g., rolling shutter distortion of a CMOS sensor), yaw movement, or depth movement (e.g., zoom in or zoom out).

In operation 1730, the electronic device 101 according to an embodiment may select first images corresponding to a stabilization section from among the plurality of images. For example, the stabilization section detection module 320 may receive the plurality of images with hand shaking correction performed, and select the first images corresponding to the stabilization section from among the plurality of input images. The stabilization section may refer to images captured in a section without hand shaking among the plurality of images.

According to an embodiment of the disclosure, to determine the stabilization section, the stabilization section detection module 320 may estimate a first-order regression straight line model, as described with reference to FIGS. 10 to 12, and calculate a coefficient of determination (R2) representing the ratio of errors between the regression straight line model and the actual motion. Based on the slope of the first-order regression straight line model and the coefficient of determination, the stabilization section detection module 320 may determine whether a specific section among the plurality of images is a stabilization section.

In operation 1740, the electronic device 101 according to an embodiment may generate (e.g., output) a second image, which is a final synthesized image, by synthesizing the selected first images. For example, the ratio adjustment module 330 may determine a synthesis ratio for synthesizing the synthesized image of the existing frames and an image of an input frame, using the method described with reference to FIGS. 15 and 16. The synthesis module (e.g., the synthesis module 340 in FIG. 3A) may generate the second image, which is the final synthesized image, by synthesizing the first images corresponding to the stabilization section based on the synthesis ratio set by the ratio adjustment module (e.g., the ratio adjustment module 330 in FIG. 3A). The second image may be a result image obtained by synthesizing the image that was input most recently among the first images.

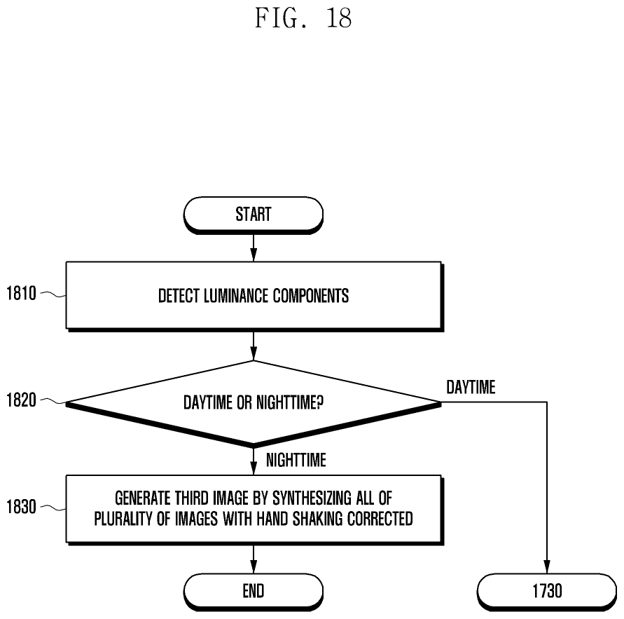

FIG. 18 is a flowchart illustrating operations for an electronic device to determine a method for synthesizing images based on whether or not the shooting is daytime shooting according to an embodiment of the disclosure.

At least some of the operations illustrated in FIG. 18 may be omitted. At least some of operations mentioned with reference to other drawings in the disclosure may be additionally inserted before or after at least some of the operations illustrated in FIG. 18. For example, FIG. 18 may be a flowchart illustrating operations performed after the operation 1720 described with reference to FIG. 17.

In the following embodiment of the disclosure, the respective operations may be performed sequentially, but are not necessarily performed sequentially. For example, the order of respective operations may be changed, and at least two operations may be performed in parallel.

The operations illustrated in FIG. 18 may be performed by the processor 120 (e.g., the processor 120 in FIG. 1). For example, the memory 130 (e.g., the memory 130 in FIG. 1) of the electronic device 101 may store instructions that, when executed, cause the processor 120 to perform at least some of the operations illustrated in FIG. 18. Hereinafter, the operations for the electronic device 101 according to an embodiment to determine a method for synthesizing images based on whether or not the shooting is daytime shooting will be described with reference to FIG. 18.

Referring to FIG. 18, in operation 1810, the electronic device 101 according to an embodiment may detect luminance components from a plurality of input images. For example, a luminance detection module (e.g., the luminance detection module 350 in FIG. 3A) may detect luminance components by region from a single image or at least some images among the plurality of images, and may calculate a representative value (e.g., a median, a mode, or an average) of the luminance components by region. For example, the luminance detection module 350 may identify the image brightness by region from a single image or at least some images among the plurality of images, and may calculate a representative value (e.g., a median, a mode, or an average) of the image brightness by region.

In operation 1820, the electronic device 101 according to an embodiment may determine whether shooting is daytime shooting or nighttime shooting, based on the detected luminance components. For example, the luminance detection module 350 may determine that shooting is daytime shooting if the representative value of the luminance components by region is greater than a specified first threshold value, and determine that shooting is nighttime shooting if the representative value is less than or equal to the first threshold value.

According to an embodiment of the disclosure, the luminance detection module 350 may determine whether shooting is daytime shooting or nighttime shooting, by using an illuminance sensor in addition to a method of detecting luminance components from a plurality of images. For example, the luminance detection module 350 may obtain an illuminance value corresponding to the external illuminance of the electronic device 101 using an illuminance sensor, and determine whether shooting is daytime shooting or nighttime shooting based on the obtained illuminance value. The luminance detection module 350 may determine that shooting is daytime shooting if the illuminance value obtained using the illuminance sensor is greater than a specified second threshold value, and determine that shooting is nighttime shooting if the illuminance value is less than or equal to the second threshold value.

According to an embodiment of the disclosure, based on determining that shooting is daytime shooting, the electronic device 101 may perform operation 1730 described with reference to FIG. 7.

According to one embodiment of the disclosure, based on determining that shooting is nighttime shooting, the electronic device 101 may perform operation 1830.

In operation 1830, the electronic device 101 according to an embodiment may generate (e.g., output) a third image, which is a final synthesized image, by synthesizing all of the plurality of images with hand shaking corrected. For example, in the case of nighttime shooting, the electronic device 101 according to an embodiment may be configured to synthesize all of the plurality of images with hand shaking corrected, regardless of whether a stabilization section exists.

According to various embodiments of the disclosure, an electronic device (e.g., the electronic device 101 in FIG. 1, 3A or 3B) includes memory (e.g., the memory 130 in FIG. 1, 3A or 3B), a camera module (e.g., the camera module 180 in FIG. 1, 2, 3A or 3B), and a processor (e.g., the processor 120 in FIG. 1 or 3A or the image signal processor 260 in FIG. 2 or 3B) operatively connected to the camera module. The processor may be configured to acquire a plurality of consecutive images by using the camera module, to perform hand shaking correction for the plurality of images, to select, from the plurality of images with hand shaking correction performed, first images included in a stabilization section determined based on a motion vector, to determine whether shooting is daytime shooting or nighttime shooting, based on luminance components associated with the plurality of images, and to generate a second image, which is a slow shutter image, by synthesizing the selected first images, based on determining that the shooting is the daytime shooting.

According to various embodiments of the disclosure, the selected first images may be selected based on one or more or all frames included in the stabilization section.

According to various embodiments of the disclosure, the processor may be configured not to detect the stabilization section in the plurality of images with hand shaking correction performed, based on determining that the shooting is the nighttime shooting.

According to various embodiments of the disclosure, the processor may be configured to, in case of detecting a plurality of stabilization sections from the plurality of images with hand shaking correction performed, select a stabilization section including a largest number of images from among the plurality of stabilization sections, and generate the second image by synthesizing images included in the selected stabilization section.

According to various embodiments of the disclosure, the processor may be configured to, in case of detecting a plurality of stabilization sections from the plurality of images with hand shaking correction performed, select a stabilization section most recently detected from among the plurality of stabilization sections, and generate the second image by synthesizing images included in the selected stabilization section.

According to various embodiments of the disclosure, the processor may be configured to search for a motion vector of each of the plurality of images with hand shaking correction performed in units of a specified size of buffer memory and sequentially search for the plurality of images, to determine a trend of movements of a specific section corresponding to the specified size by using a statistical calculation method for m motion vectors corresponding to the specified size and determine a degree of dispersion of the motion vectors from the trend of movements, and when the trend of movements of the specific section is less than a first threshold value and a determination coefficient indicating the degree of dispersion of the motion vectors is greater than a second threshold value, to determine that the specific section is a stabilization section.

According to various embodiments of the disclosure, the processor may be configured to sequentially store the motion vector of each of the plurality of images in the buffer memory, when a new motion vector is stored in the buffer memory, to delete a motion vector stored first among previously stored motion vectors, and to perform a search for the stabilization section by using the statistical calculation method for the motion vectors stored in the buffer memory.

According to various embodiments of the disclosure, the processor may be configured to, in case of detecting a plurality of stabilization sections from the plurality of images with hand shaking correction performed, set a synthesis ratio to 1 for a non-stabilization section, set the synthesis ratio to a value less than 1 and greater than 0 for the stabilization section, and synthesize images according to the synthesis ratio and Equation 3.

According to various embodiments of the disclosure, the processor may be configured to, when a non-stabilization section is detected after a first stabilization section is detected from the plurality of images, set a new image input in the non-stabilization section as an output image instead of a previously synthesized image, and when a second stabilization section is detected after the non-stabilization section, perform a new image synthesis.

According to various embodiments of the disclosure, the processor may be configured to, in case of detecting a plurality of stabilization sections from the plurality of images with hand shaking correction performed, set a synthesis ratio to 0 for a non-stabilization section, set the synthesis ratio to a value less than 1 and greater than 0 for the stabilization section, and synthesize images according to the synthesis ratio and Equation 3.

According to various embodiments of the disclosure, the processor may be configured to, when a non-stabilization section is detected after a first stabilization section is detected from the plurality of images, set a previously synthesized image as an output image, when a second stabilization section is detected after the non-stabilization section, perform additional image synthesis from the previously synthesized image, and set a synthesis ratio of the second stabilization section to be less than or equal to a synthesis ratio of the first stabilization section.

According to various embodiments of the disclosure, the processor may be configured to detect external illumination of the electronic device by using an illumination sensor, to determine whether shooting is daytime shooting or nighttime shooting, based on a result of comparing the external illumination with a threshold value, to generate the second image, which is a slow shutter image, by synthesizing the selected first images, based on determining that the shooting is the daytime shooting, and to generate a third image, which is a slow shutter image, by synthesizing the plurality of images with hand shaking correction performed, based on determining that the shooting is the nighttime shooting.

According to various embodiments of the disclosure, a method of an electronic device may include acquiring a plurality of consecutive images by using a camera module of the electronic device, performing hand shaking correction for the plurality of images, selecting, from the plurality of images with hand shaking correction performed, first images included in a stabilization section determined based on a motion vector, determining whether shooting is daytime shooting or nighttime shooting, based on luminance components associated with the plurality of images, and generating a second image, which is a slow shutter image, by synthesizing the selected first images, based on determining that the shooting is the daytime shooting.

According to various embodiments of the disclosure, selecting the first images may be performed based on one or more or all frames included in the stabilization section.

According to various embodiments of the disclosure, the method may further include, in case of detecting a plurality of stabilization sections from the plurality of images with hand shaking correction performed, selecting a stabilization section including a largest number of images from among the plurality of stabilization sections, and generating the second image by synthesizing images included in the selected stabilization section.

According to various embodiments of the disclosure, the method may further include, in case of detecting a plurality of stabilization sections from the plurality of images with hand shaking correction performed, selecting a stabilization section most recently detected from among the plurality of stabilization sections, and generating the second image by synthesizing images included in the selected stabilization section.

According to various embodiments of the disclosure, the method may further include searching for a motion vector of each of the plurality of images with hand shaking correction performed in units of a specified size of buffer memory while sequentially searching for the plurality of images, determining a trend of movements of a specific section corresponding to the specified size by using a statistical calculation method for m motion vectors corresponding to the specified size and a degree of dispersion of the motion vectors from the trend of movements, and when the trend of movements of the specific section is less than a first threshold value and a determination coefficient indicating the degree of dispersion of the motion vectors is greater than a second threshold value, determining that the specific section is a stabilization section.

According to various embodiments of the disclosure, the method may further include, when a non-stabilization section is detected after a first stabilization section is detected from the plurality of images, setting a new image input in the non-stabilization section as an output image instead of a previously synthesized image, and when a second stabilization section is detected after the non-stabilization section, performing a new image synthesis.

According to various embodiments of the disclosure, the method may further include, when a non-stabilization section is detected after a first stabilization section is detected from the plurality of images, setting a previously synthesized image as an output image, when a second stabilization section is detected after the non-stabilization section, performing additional image synthesis from the previously synthesized image, and setting a synthesis ratio of the second stabilization section to be less than or equal to a synthesis ratio of the first stabilization section.

According to various embodiments of the disclosure, the method may further include detecting external illumination of the electronic device by using an illumination sensor, determining whether shooting is daytime shooting or nighttime shooting, based on a result of comparing the external illumination with a threshold value, generating the second image, which is a slow shutter image, by synthesizing the selected first images, based on determining that the shooting is the daytime shooting, and generating a third image, which is a slow shutter image, by synthesizing the plurality of images with hand shaking correction performed, based on determining that the shooting is the nighttime shooting.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory storing one or more computer programs;
a camera module; and
one or more processors communicatively coupled to the camera module and the memory,
wherein the one or more computer programs include computer-executable instructions that, when executed by the one or more processors individually or collectively, cause the electronic device to:
acquire a plurality of consecutive images by using the camera module,
perform hand shaking correction for the plurality of consecutive images,
select, from the plurality of consecutive images with hand shaking correction performed, first images included in a stabilization section determined based on a motion vector,
determine whether shooting is daytime shooting or nighttime shooting, based on luminance components associated with the plurality of consecutive images, and
generate a second image, which is a slow shutter image, by synthesizing the selected first images, based on determining that the shooting is the daytime shooting.

2. The electronic device of claim 1, wherein the selected first images are selected based on one or more or all frames included in the stabilization section.

3. The electronic device of claim 1, wherein the one or more computer programs further include computer-executable instructions that, when executed by the one or more processors individually or collectively, cause the electronic device not to detect the stabilization section in the plurality of consecutive images with hand shaking correction performed, based on determining that the shooting is the nighttime shooting.

4. The electronic device of claim 1, wherein the one or more computer programs further include computer-executable instructions that, when executed by the one or more processors individually or collectively, cause the electronic device to:
in case of detecting a plurality of stabilization sections from the plurality of consecutive images with hand shaking correction performed, select a stabilization section including a largest number of images from among the plurality of stabilization sections, and
generate the second image by synthesizing images included in the selected stabilization section.

5. The electronic device of claim 1, wherein the one or more computer programs further include computer-executable instructions that, when executed by the one or more processors individually or collectively, cause the electronic device to:
in case of detecting a plurality of stabilization sections from the plurality of consecutive images with hand shaking correction performed, select a stabilization section most recently detected from among the plurality of stabilization sections, and
generate the second image by synthesizing images included in the selected stabilization section.

6. The electronic device of claim 1, wherein the one or more computer programs further include computer-executable instructions that, when executed by the one or more processors individually or collectively, cause the electronic device to:
search for a motion vector of each of the plurality of consecutive images with hand shaking correction performed in units of a specified size of buffer memory and sequentially search for the plurality of consecutive images,
determine a trend of movements of a specific section corresponding to the specified size by using a statistical calculation method for m motion vectors corresponding to the specified size and determine a degree of dispersion of the motion vectors from the trend of movements, and
when the trend of movements of the specific section is less than a first threshold value and a determination coefficient indicating the degree of dispersion of the motion vectors is greater than a second threshold value, determine that the specific section is a stabilization section.

7. The electronic device of claim 6, wherein the one or more computer programs further include computer-executable instructions that, when executed by the one or more processors individually or collectively, cause the electronic device to:
sequentially store the motion vector of each of the plurality of consecutive images in the buffer memory,
when a new motion vector is stored in the buffer memory, delete a motion vector stored first among previously stored motion vectors, and
perform a search for the stabilization section by using the statistical calculation method for the motion vectors stored in the buffer memory.

8. The electronic device of claim 1, wherein the one or more computer programs further include computer-executable instructions that, when executed by the one or more processors individually or collectively, cause the electronic device to:
in case of detecting a plurality of stabilization sections from the plurality of consecutive images with hand shaking correction performed,
set a synthesis ratio to 1 for a non-stabilization section;
set the synthesis ratio to a value less than 1 and greater than 0 for the stabilization section; and
synthesize images according to the synthesis ratio and an equation below,
Output=In1·Ratio+In2·(1−Ratio)
where Output denotes an image output by synthesis, In1 denotes a newly input image, In2 denotes a previously synthesized image, and Ratio denotes the synthesis ratio.

9. The electronic device of claim 8, wherein the one or more computer programs further include computer-executable instructions that, when executed by the one or more processors individually or collectively, cause the electronic device to:
when a non-stabilization section is detected after a first stabilization section is detected from the plurality of consecutive images, set a new image input in the non-stabilization section as an output image instead of a previously synthesized image, and
when a second stabilization section is detected after the non-stabilization section, perform a new image synthesis.

10. The electronic device of claim 1, wherein the one or more computer programs further include computer-executable instructions that, when executed by the one or more processors individually or collectively, cause the electronic device to:
in case of detecting a plurality of stabilization sections from the plurality of consecutive images with hand shaking correction performed,
set a synthesis ratio to 0 for a non-stabilization section,
set the synthesis ratio to a value less than 1 and greater than 0 for the stabilization section, and
synthesize images according to the synthesis ratio and an equation below,
Output=In1·Ratio+In2·(1−Ratio)
where Output denotes an image output by synthesis, In1 denotes a newly input image, In2 denotes a previously synthesized image, and Ratio denotes the synthesis ratio.

11. The electronic device of claim 10, wherein the one or more computer programs further include computer-executable instructions that, when executed by the one or more processors individually or collectively, cause the electronic device to:
when a non-stabilization section is detected after a first stabilization section is detected from the plurality of consecutive images, set a previously synthesized image as an output image,
when a second stabilization section is detected after the non-stabilization section, perform additional image synthesis from the previously synthesized image, and
set a synthesis ratio of the second stabilization section to be less than or equal to a synthesis ratio of the first stabilization section.

12. The electronic device of claim 1, wherein the one or more computer programs further include computer-executable instructions that, when executed by the one or more processors individually or collectively, cause the electronic device to:
detect external illumination of the electronic device by using an illumination sensor,
determine whether shooting is daytime shooting or nighttime shooting, based on a result of comparing the external illumination with a threshold value,
generate the second image, which is a slow shutter image, by synthesizing the selected first images, based on determining that the shooting is the daytime shooting, and
generate a third image, which is a slow shutter image, by synthesizing the plurality of consecutive images with hand shaking correction performed, based on determining that the shooting is the nighttime shooting.

13. A method performed by an electronic device, the method comprising:
acquiring, by the electronic device, a plurality of consecutive images by using a camera module of the electronic device;
performing, by the electronic device, hand shaking correction for the plurality of consecutive images;
selecting, by the electronic device from the plurality of consecutive images with hand shaking correction performed, first images included in a stabilization section determined based on a motion vector;
determining, by the electronic device, whether shooting is daytime shooting or nighttime shooting, based on luminance components associated with the plurality of consecutive images; and
generating, by the electronic device, a second image, which is a slow shutter image, by synthesizing the selected first images, based on determining that the shooting is the daytime shooting.

14. The method of claim 13, wherein the selecting of the first images is performed based on one or more or all frames included in the stabilization section.

15. The method of claim 13, further comprising:
not detecting the stabilization section in the plurality of consecutive images with hand shaking correction performed, based on determining that the shooting is the nighttime shooting.

16. The method of claim 13, further comprising:
in case of detecting a plurality of stabilization sections from the plurality of consecutive images with hand shaking correction performed, selecting a stabilization section including a largest number of images from among the plurality of stabilization sections; and
generating the second image by synthesizing images included in the selected stabilization section.

17. The method of claim 13, further comprising:
in case of detecting a plurality of stabilization sections from the plurality of consecutive images with hand shaking correction performed, selecting a stabilization section most recently detected from among the plurality of stabilization sections; and
generating the second image by synthesizing images included in the selected stabilization section.

18. The method of claim 13, further comprising:
searching for a motion vector of each of the plurality of consecutive images with hand shaking correction performed in units of a specified size of buffer memory and sequentially search for the plurality of consecutive images;
determining a trend of movements of a specific section corresponding to the specified size by using a statistical calculation method for m motion vectors corresponding to the specified size and determine a degree of dispersion of the motion vectors from the trend of movements; and
when the trend of movements of the specific section is less than a first threshold value and a determination coefficient indicating the degree of dispersion of the motion vectors is greater than a second threshold value, determining that the specific section is a stabilization section.

19. One or more non-transitory computer-readable storage media storing one or more computer programs including computer-executable instructions that, when executed by one or more processors of an electronic device individually or collectively, cause the electronic device to perform operations, the operations comprising:
acquiring, by the electronic device, a plurality of consecutive images by using a camera module of the electronic device;
performing, by the electronic device, hand shaking correction for the plurality of consecutive images;
selecting, by the electronic device from the plurality of consecutive images with hand shaking correction performed, first images included in a stabilization section determined based on a motion vector;
determining, by the electronic device, whether shooting is daytime shooting or nighttime shooting, based on luminance components associated with the plurality of consecutive images; and
generating, by the electronic device, a second image, which is a slow shutter image, by synthesizing the selected first images, based on determining that the shooting is the daytime shooting.

20. The one or more non-transitory computer-readable storage media of claim 19, wherein the selecting of the first images is performed based on one or more or all frames included in the stabilization section.
